(19) United States
(12) Patent Application Publication
(10) Pub. No.: US 2018/0024648 A1
(43) Pub. Date: Jan. 25, 2018

(54) INPUT DEVICE

(71) Applicant: ALPS ELECTRIC CO., LTD., Tokyo (JP)

(72) Inventor: Kenji WATANABE, Tokyo (JP)

(21) Appl. No.: 15/658,555

(22) Filed: Jul. 25, 2017

(30) Foreign Application Priority Data
Jul. 25, 2016 (JP) 2016-145653

(51) Int. Cl. G06F 3/0354; G01L 1/20; G01L 1/14; G06F 3/044

(52) U.S. Cl. CPC G06F 3/0354; G06F 3/044; G01L 1/205; G01L 1/14; G06F 2203/04105

(57) ABSTRACT

An input device includes a plate-shaped substrate that receives an input operation, supports that elastically support the substrate, force sensor units that detect the force applied to the substrate, and an operation body disposed on the substrate. The force sensor units are disposed around the operation body and are spaced apart from each other in different directions with respect to the operation body when the substrate is viewed in plan view.

### CLAIM OF PRIORITY

This application contains subject matter related to and claims the benefit of Japanese Patent Application No. 2016-145653 filed on Jul. 25, 2016, the entire contents of which is incorporated herein by reference.

### BACKGROUND OF THE DISCLOSURE

### 1. Field of the Disclosure

Embodiments of the present disclosure relate to an input device capable of controlling a coordinate of a cursor or the like on a display.

### 2. Description of the Related Art

An input device that controls a coordinate of a cursor or the like on a display is used in personal computer, and the like. For example, Japanese Unexamined Patent Application Publication No. 2005-141462 discloses a coordinate input device that performs an operation of tilting an operation portion.

FIG. 9 is a perspective view of a coordinate input device 900 of the related art described in Japanese Unexamined Patent Application Publication No. 2005-141462. As illustrated in FIG. 9, an operation member 902 formed by molding a synthetic resin or the like is disposed in the coordinate input device 900 of the related art. In the operation member 902, a base portion 903 that has a predetermined thickness and that has a substantially octagonal external form is formed, and a square and columnar operation portion 904 is formed erect from the middle portion of the base portion 903. Furthermore, a cap 905 formed of rubber or the like is press-fitted onto and attached to the operation portion 904. Beam portions 903b are formed in the base portion 903 and around the operation portion 904 in four portions at equal intervals. Recesses 903c of a predetermined depth are formed on the underside of the base portion 903. In the above portions, the thicknesses of the beam portions 903b are thin such that deflection can occur. Furthermore, a flexible substrate 906 formed of polyimide resin is fixed to the top wall surface of the recesses 903c that is the underside of the base portion 903 with an adhesive or the like, and deformation detection elements, such as resistive elements, are formed at portions opposing the beam portions 903b and in four portions at equal intervals.

Furthermore, the deformation detection elements interlocking with the deflection of the plurality of beam portions 903b that occur when an operation of tilting the operation portion 904 is performed is elongated and contracted with the deflection through the flexible substrate 906. Resistance values change with the elongation and contraction of the deformation detection elements. The coordinate input device 900 detects a difference in voltage across the deformation detection elements, so that a cursor or the like on a display of a personal computer, for example, can be moved to a desired position.

In recent years, reduction in weight and thickness of personal computers and the like has progressed, and keyboards with which characters and the like are typed have become thinner. At the same time, there is a need to reduce the thickness of the input device that controls the coordinate of a cursor and the like.

However, the height dimension of the operation portion 904 of the coordinate input device 900 of the related art is large, and when the height dimension is reduced, the operability in controlling the coordinate becomes degraded disadvantageously. Accordingly, there is a problem in that reduction of height is difficult. These and other drawbacks exist.

### SUMMARY OF THE DISCLOSURE

Embodiments of the present disclosure are made to overcome the above problem and provides an input device having excellent operability even when the height thereof is reduced.

An input device according to an example embodiment includes a plate-shaped substrate that receives an input operation, supports that elastically support the substrate, force sensor units that detect force applied to the substrate, and an operation body disposed on the substrate. In the input device, the force sensor units are disposed around the operation body and are spaced apart from each other in different directions with respect to the operation body when the substrate is viewed in plan view.

With such a configuration, since the force sensor units are disposed around the operation body in different directions, when an input operation is performed on the substrate through the operation body, the force applied to the substrate is accurately detected by each of the force sensor units. Accordingly, even if the height of the operation body is reduced, the input operation through tilting of the substrate can be performed and can be controlled in a desirable manner.

Furthermore, in the input device according to the an example embodiment, the substrate may have a rectangular shape in plan view, and the force sensor units may each be disposed in a vicinity of one of four corners of the substrate.

With such a configuration, since the force sensor units are disposed in four directions around the operation body, and the separated distances between the operation body and the force sensor units are large, the force applied to the substrate is detected in a further accurate manner.

Furthermore, in the input device according to an example embodiment, the force sensor units may each include an elastic member, and a variable resistance portion, a resistance value of which changes in accordance with elastic deformation of the elastic member, and the supports may each include an accommodation space, a volume of which elastically changes when force is applied to the substrate, and the elastic member is accommodated in the accommodation space.

With such a configuration, when force is applied to the substrate with the input operation, the volumes of the accommodation spaces elastically change, and elastic deformation occurs in the elastic members accommodated in the accommodation spaces. The resistance values of the variable resistance portions change in accordance with the elastic deformation of the elastic members, such that the force applied to the substrate can be detected accurately. With the above configuration, since the elastic deformation needed to detect the force of the input operation occurs in the supports that support the substrate, there is no need to separately provide a mechanism element in which displacement and elastic deformation for detecting the force occurs.

Furthermore, in an input device according to an example embodiment, the variable resistance portion may include two conductive members disposed in the accommodation space so as to be capable of being in contact with each other, the two conductive members having electric conductivities that are different from each other, at least one of the two conductive members may be the elastic member, at least one of the two conductive members may have a protruding surface that projects towards a portion in contact with the other of the two conductive members, and when the volume of the accommodation space changes, a contact pressure between the two conductive members may change.

With such a configuration, when the contact pressure changes, at least one of the conductive members deforms at the contact portion, and the contact areas of the two conductive members change; accordingly, the resistance value of the conductive path passing through the contact portion of the two conductive members changes.

Furthermore, in an input device according to an example embodiment, the substrate may have a first surface and a second surface that are parallel and opposed to each other, the first surface receiving the input operation, the supports may support the substrate from the second surface, in a corresponding accommodation space, the two conductive members may be aligned in a longitudinal direction that is perpendicular to the first surface and the second surface, and when force in the longitudinal direction applied to the substrate is increased through the input operation, the length of the accommodation space in the longitudinal direction may be decreased.

With such a configuration, the force sensor units can be configured easily.

Furthermore, in an input device according to an example embodiment, the operation body may include a base portion in contact with the substrate, and an operation portion that protrudes upwards from the base portion, and the base portion may include a projection that protrudes sideways with respect to the operation portion in plan view.

With such a configuration, when the operation body is tilted by operating force, since the projections press the substrate, the substrate can be tilted to an accurate orientation.

Furthermore, in an input device according to an example embodiment, the substrate may include a detection mechanism capable of measuring an electrostatic capacity, and the detection mechanism may include a plurality of electrodes arranged in a matrix, the detection mechanism detecting a coordinate of an approaching object on the substrate by a change in electrostatic capacity measured by the electrodes.

With such a configuration, the combined control that is a combination of the coordinate of an object on the substrate detected by the detection mechanism that is capable of measuring an electrostatic capacity, and the input operation, such as tilting and pressing of the operation body, detected by the force sensor units can be performed.

Furthermore, in an input device according to an example embodiment, the operation body may be formed of a conductive material and may be disposed in a slidable manner on the substrate.

With such a configuration using the conductive operation body, the coordinate of the operation body on the substrate can be detected with the change in electrostatic capacity.

Furthermore, in an input device according to an example embodiment, the operation body may be provided so as to be detachable from the substrate, and the operation body may be capable of performing an operation of tilting the substrate at any position on the substrate.

With such a configuration, the operation position of the operation body can be changed according to the preference of the operator. Furthermore, the operation body can be dismounted when not in use.

Furthermore, in an input device according to an example embodiment, the operation body may be a highly-rigid molded body.

With such a configuration, by having the operation body be a molded body so as to have a rigidity higher than that of the finger of the operator, operability becomes uniform and ease of operation is facilitated.

### BRIEF DESCRIPTION OF THE DRAWINGS

FIG. 1 is a perspective view illustrating an input device of an exemplary embodiment of the disclosure;

FIG. 2 is a plan view illustrating the input device of the exemplary embodiment of the disclosure;

FIG. 3 is a perspective view illustrating a shape of a support of the input device of the exemplary embodiment of the disclosure;

FIG. 4 is a partial cross-sectional view taken along line IV-IV in FIG. 2;

FIG. 5 is a block diagram illustrating the input device of the exemplary embodiment of the disclosure; FIG. 6 is an explanatory drawing of a cross-section that is the same as that of FIG. 4 and illustrates a state in which force is applied to a substrate;

FIG. 7 is a schematic diagram illustrating an operation body of an exemplary embodiment of the disclosure;

FIG. 8 is a schematic diagram illustrating an operation body of an exemplary embodiment of the disclosure; and

FIG. 9 is a perspective view of a coordinate input device of the related art.

### DETAILED DESCRIPTION OF THE DISCLOSURE

The following description is intended to convey a thorough understanding of the embodiments described by providing a number of specific embodiments and details involving an input device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

Hereinafter, various example embodiments of the present disclosure will be described in detail with reference to the drawings. Note that to facilitate understanding, dimensions in the drawings are changed as appropriate.

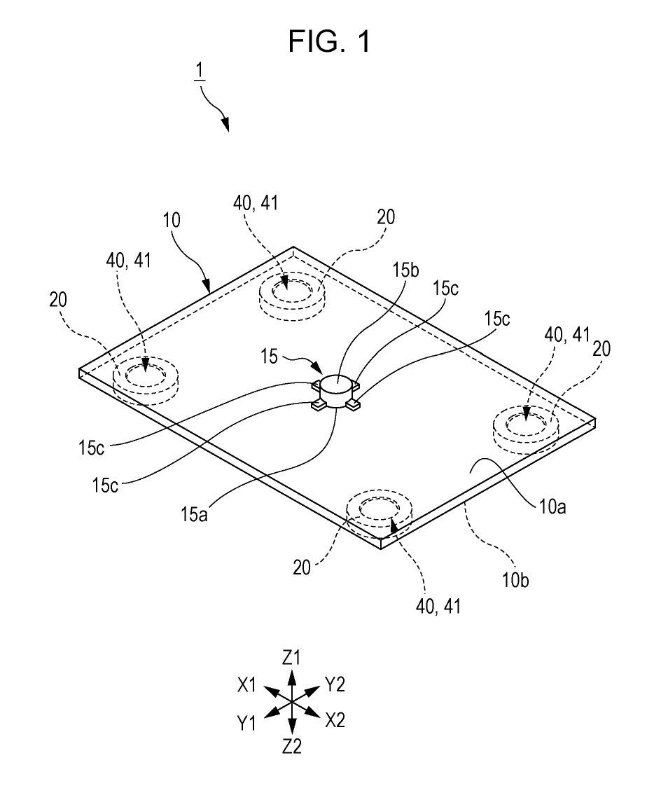

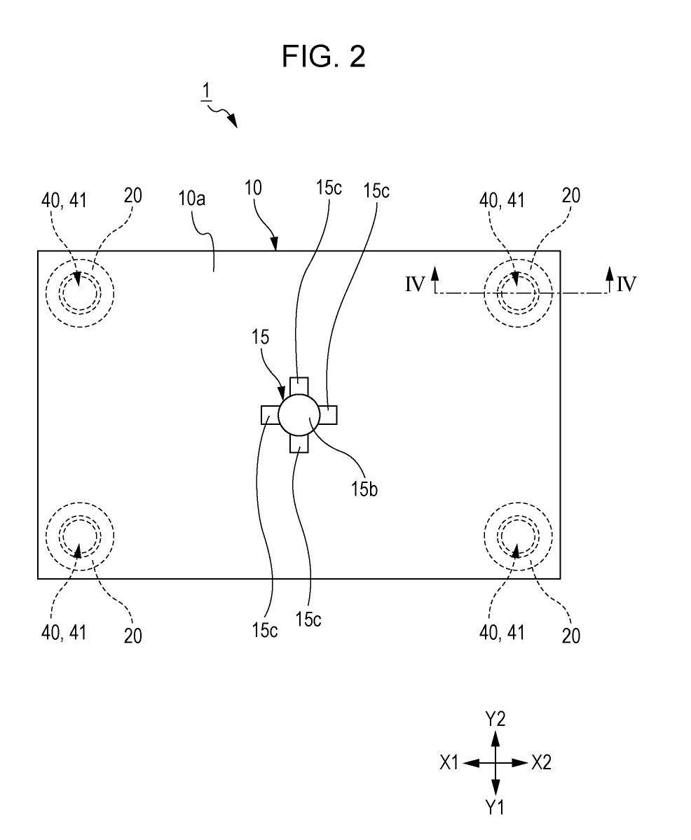

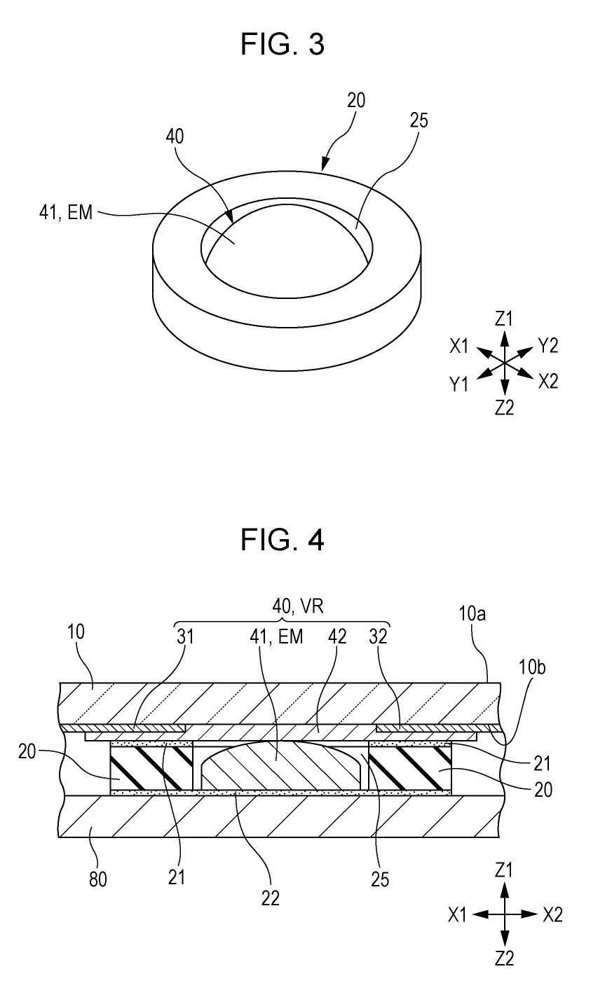

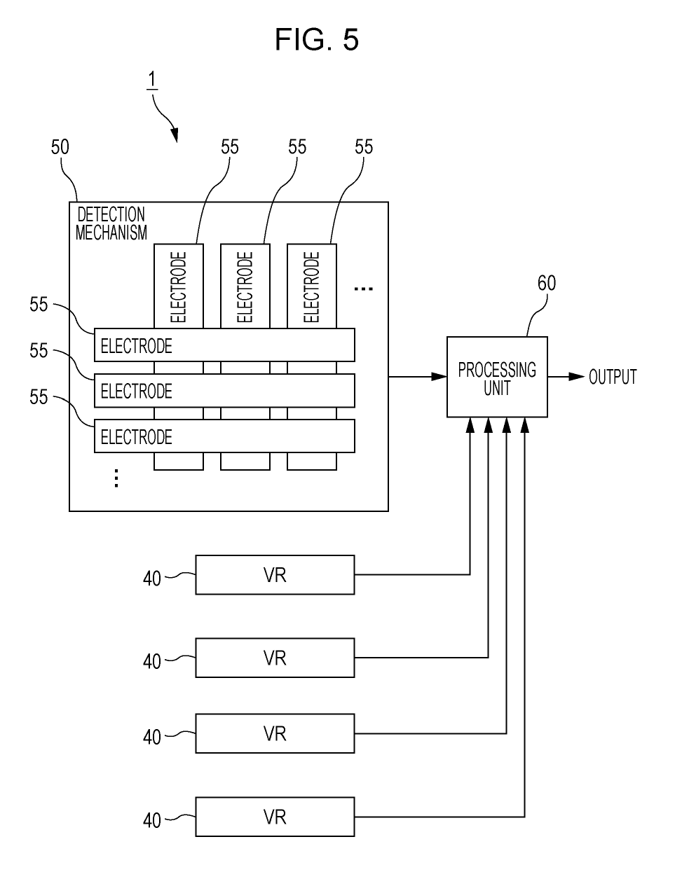

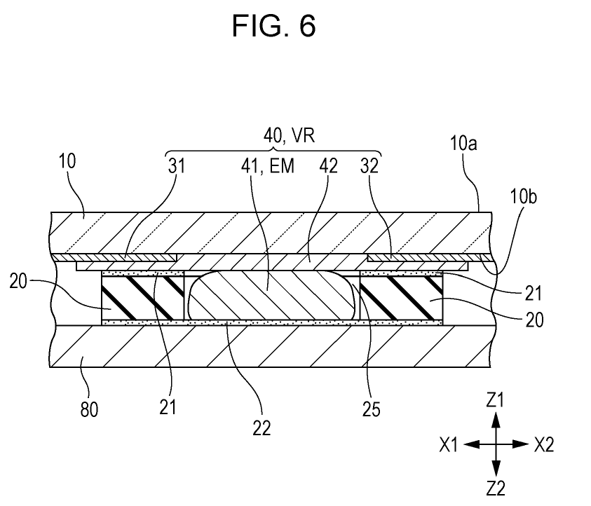

FIG. 1 is a perspective view illustrating an input device 1 of an example embodiment. FIG. 2 is a plan view illustrating the input device 1 of the present exemplary embodiment. FIG. 3 is a perspective view illustrating a shape of a support 20 according to the input device 1. FIG. 4 is a partial cross-sectional view taken along line IV-IV in FIG. 2. FIG. 5 is a block diagram illustrating the input device 1. FIG. 6 is an explanatory drawing of a cross-section that is the same as that of FIG. 4 and illustrates a state in which force is applied to a substrate 10.

As illustrated in FIG. 1, the input device 1 according to an example embodiment may include a plate-shaped substrate 10, an operation body 15 disposed on the substrate 10, supports 20 that elastically support the substrate 10, and force sensor units 40 each disposed in the vicinity of one of the four corners of the substrate 10.

The substrate 10 may include, for example, a tabular glass plate and a printed wiring board integrally adhered thereto, and may have a first surface 10a and a second surface 10b that are parallel and opposed to each other. As illustrated in FIG. 2, the substrate 10 may be rectangular in plan view. Note that the printed wiring board of the substrate 10 may be a printed wiring board in which wiring formed of copper foil or the like is laid on an insulating substrate formed of synthetic resin. In such an embodiment, the printed wiring board may be a multilayer wiring board provided with a plurality of wiring layers. The substrate 10 may be disposed so as to receive an input operation of the operator performed on the first surface 10a.

The operation body 15 may be a highly-rigid molded body and may be formed of a conductive material. The operation body 15 may be formed of, for example, a metal material, such as aluminum, or a synthetic resin material containing conductive carbon or the like. As illustrated in FIGS. 1 and 2, the operation body 15 may include a base portion 15a that is in contact with the first surface 10a of the substrate 10, an operation portion 15b that protrudes upwards from the base portion 15a, and projections 15c that are provided so as to protrude sideways from the operation portion 15b in in plan view. The operation body 15 may be disposed on the substrate 10, and transmits operating force applied to the operation portion 15b to the substrate 10.

Four supports 20 may be disposed on the second surface 10b side of the substrate 10. Each support 20 may be formed of an elastic material such as, for example, polyurethane or silicone rubber, so as to enable elastic deformation thereof. As illustrated in FIG. 2, the supports 20 each may be disposed in the vicinity of one of the four corners of the substrate 10 when the substrate 10 is viewed in plan view. In such an embodiment, as illustrated in FIG. 3, the support 20 may be formed in a cylindrical shape, and an accommodation space 25 may be provided on the inner side thereof. Note that as illustrated in FIG. 4, the supports 20 may be mounted on a base 80 (a housing or a beam member of an input device, such as a personal computer) with an adhesive 22 in between. The substrate 10 may be adhered to the supports 20 with an adhesive 21 such that the supports 20 support the substrate 10 from the second surface 10b side.

Each force sensor unit 40 may include an elastic member EM, and a variable resistance portion VR in which the resistance value changes according to the elastic deformation of the elastic member EM. As illustrated in FIG. 4, each elastic member EM may be accommodated in the accommodation space 25 of the corresponding support 20, and may be mounted on the base 80 with the adhesive 22 in between. Each variable resistance portion VR may include two conductive members 41 and 42 that have different electric conductivities. The two conductive members 41 and 42 may be disposed in the accommodation space 25 so as to be capable of being in contact with each other. Note that as illustrated in FIG. 4, in the present example, the conductive members 41 serve as the elastic members EM. The conductive members 41 employed in the present example may be formed of conductive rubber. Each conductive member 41 may include a protruding surface that projects towards the portion that comes in contact with the corresponding conductive member 42.

As illustrated in FIG. 4, each conductive member 42 may be disposed on the second surface 10b side of the substrate 10. Each conductive member 42 may be a pattern of a resistive element (a thin film) such as carbon, and may be adjusted to have a low electric conductivity (a high resistance value) compared with that of the conductive members 41. As illustrated in FIG. 4, each conductive member 42 may be electrically connected to electrode patterns 31 and 32 that are provided in the printed wiring board constituting the substrate 10, and connected to a processing unit 60 described later through the electrode patterns 31 and 32.

The input device 1 according to an example embodiment may include, in the substrate 10, a detection mechanism 50 capable of measuring an electrostatic capacity. As illustrated in FIG. 5, the detection mechanism 50 may include a plurality of electrodes 55 arranged in a matrix, and may be connected to the processing unit 60 described later. With the above, the input device 1 may be capable of detecting a coordinate of an approaching object on the substrate 10 with the change in electrostatic capacity measured with the electrodes 55. The plurality of electrodes 55 may be formed by a wiring pattern of the printed wiring board constituting the substrate 10. Note that the printed wiring board employed in the present example may be a multilayer wiring board in which the plurality of electrodes 55 and the electrode patterns 31 and 32 are layered on different layers.

The processing unit 60 may be a circuit that controls the general operation of the input device 1 and, for example, may be constituted by a semiconductor integrated circuit (not shown) that performs processing according to instruction codes of a program stored in a storage unit.

The input device 1 of the present example may be capable of detecting planar coordinate information of the operation body 15 mounted on the substrate 10, and may be capable of, with the operating force applied to the operation body 15, detecting information of the direction of a tilting operation performed on the substrate 10. With the above, other than controlling a coordinate of a cursor or the like on the display by sliding the operation body 15 on the substrate 10, for example, the following control can be performed.

In the input device 1 of the present example, when the substrate 10 is viewed in plan view, the supports 20 and the force sensor units 40 may be disposed around the operation body 15 and are spaced apart from each other in different directions with respect to the operation body 15. When the operation body 15 is operated so as to be tilted on the substrate 10, pressing force that is applied to the supports 20 disposed in the vicinity of the four corners of the substrate 10 is different at the four disposed positions; accordingly, the support 20 applied with a larger pressing force is compressed more and the substrate 10 can be made to perform the tilting operation. Specifically, when force in the longitudinal direction applied to the substrate 10 at the position where the support 20 is disposed is increased through an input operation, as illustrated in FIG. 6, the length of the support 20 in the longitudinal direction decreases, and the volume of the accommodation space 25 changes elastically. When the volumes of the accommodation spaces 25 decrease, contact pressures between the two conductive members 41 and 42 provided in the force sensor units 40 increase, and the conductive members 41 serving as elastic members EM accommodated in the accommodation spaces 25 elastically deform. The two conductive members 41 and 42 may be disposed in each of the accommodation spaces 25 so as to be aligned in the longitudinal direction that is vertical to the first surface 10a and the second surface 10b. Each conductive member 41 may have a protruding surface that projects towards the portion that comes in contact with the corresponding conductive member 42, and as illustrated in FIG. 6, when each conductive member 41 is elastically deformed, the contact area of the corresponding conductive member 42 increases. Since the contact area of the two conductive members 41 and 42 changes, the resistance value of the conductive path passing through the contact portion of the two conductive members 41 and 42 changes. Since the resistance value of the conductive member 42 is higher than that of the conductive member 41, the resistance value of the conductive member 41 acts to reduce the combined resistance value in the area where the conductive member 41 is in contact with the conductive member 42. The pressing force at the position where the support 20 is disposed can be detected by detecting the electric signal corresponding to the combined resistance value with the processing unit 60. With the above, control that moves the coordinate of the cursor or the like on the display, for example, can be performed without, for example, sliding the operation body 15 on the substrate 10. Furthermore, when the operation body 15 is at a specific coordinate on the substrate 10, an operation of tilting the operation body 15 enables allocation of a control instruction different from the above control. For example, control of jumping the displayed content on the display to a content of a different display can be performed. Note that rather than tilting the operation body 15, an operation of pressing the substrate 10, on the whole, can be performed as well.

Since the input device 1 detects the coordinate of an approaching object on the substrate 10 with the change in electrostatic capacity measured with the electrodes 55, the planar dimension of the substrate 10 is relatively large. Accordingly, an increase in the separated distance between the force sensor units 40 disposed in the vicinity of the four corners of the substrate 10 and the operation body 15 can be facilitated.

Accordingly, in the input device 1 of the present example, since the force sensor units 40 are disposed so as to surround the operation body 15 in different directions, the input operation through tilting of the substrate 10 can be performed even if the height of the operation portion is reduced. When an input operation is performed on the substrate 10 through the operation body 15, the force applied to the substrate 10 is detected by each of the force sensor units 40. Accordingly, when the force sensor units 40 at four portions detect different magnitudes of force, it can be known that the substrate 10 is inclined. Furthermore, in the input device 1 of the present exemplary embodiment, when the operation body 15 is tilted by operating force, since the projections 15c press the substrate 10, the substrate 10 can be tilted to an accurate orientation. Moreover, since the force sensor units 40 are disposed in the vicinity of the four corners of the substrate 10 and the separated distances between the operation body 15 and the force sensor units 40 are large, the force applied to the substrate 10 through the operation body 15 can be detected accurately.

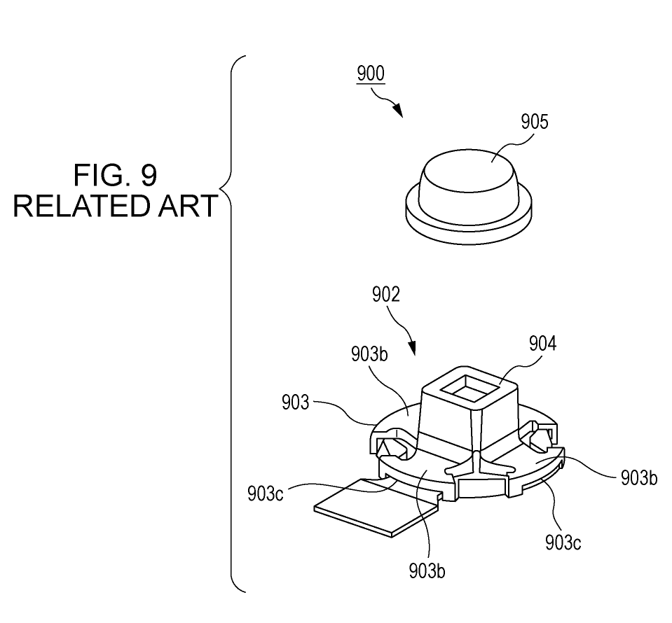

Different from the present example, in a known coordinate input device 900 that employs a conventional deformation detection element, as illustrated in FIG. 9, a beam portions 903b is provided in a vicinity of an operation portion 904, and the deflection of the beam portions 903b is detected by the deformation detection element. Accordingly, the height dimension of the operation portion 904 is set large so that the deflection of the beam portions 903b can be made large. Furthermore, since the output of the deformation detection element changes by a slight difference in deflection, the coordinate input device 900 is not suitable for input in which the operation is performed little by little.

In the input device 1 of the present example, since the separated distances between the operation body 15 and the force sensor units 40 are large, the force applied to the operation body 15 can be detected accurately, and the operation can be performed without any discomfort even when the operation body 15 is moved little by little.

Moreover, in the input device 1 of the present example, when force is applied to the substrate 10 with the input operation, the volumes of the accommodation spaces 25 of the supports 20 elastically change, and elastic deformation occurs in the elastic members EM of the force sensor units 40 accommodated in the accommodation spaces 25. Since the elastic deformation needed to detect the force of the input operation occurs in the supports 20 that support the substrate 10, by providing the elastic members EM of the force sensor units 40 in the accommodation spaces 25 of the supports 20, there will be no need to separately provide a mechanism element in which displacement and elastic deformation for detecting the force occurs. Note that only a slight elastic deformation of the elastic members EM of the force sensor units 40 is needed for the detection of the force, and the tilting movement of the substrate 10 can be slight.

Furthermore, the input device 1 of the present example may include the detection mechanism 50 capable of measuring change in electrostatic capacity caused by an object approaching the substrate 10. Combined control that is a combination of the coordinate of an object on the substrate 10 detected by the detection mechanism 50, and the input operation, such as tilting and pressing of the operation body 15, detected by the force sensor units 40 can be performed. For example, in a position other than the position of the operation body 15, the detection mechanism 50 may detect a coordinate of a finger or the like approaching the substrate 10, and by a moving operation of the finger or the like, control of moving the coordinate of the cursor or the like on the display may be performed, and control of performing a different control instruction with a tilting operation of the operation body 15 may be performed as well.

Note that in the input device 1 of the present example, the operation body 15 may be formed of a conductive material. The operation body 15 can be slid on the substrate 10 and the coordinate thereof can be detected by the detection mechanism 50. Furthermore, a tilting operation of the substrate 10 can be performed at any position on the substrate 10. With such a configuration, the operation position of the operation body 15 can be changed according to the preference of the operator. Furthermore, when the operation body 15 is tilted, since the force detected by each of the force sensor units 40 is different depending on the coordinate of the operation body 15, the degree of freedom of control can be increased by the difference in the magnitude of the detected force.

Furthermore, the operation body 15 may be a molded body (metal or the like) that has a rigidity that is higher than that of the finger of the operator. With the above, operability becomes uniform and ease of operation is facilitated. Note that in the operation body 15 illustrated in FIG. 1, while the operation portion 15b has a cylindrical shape, the operation portion 15b may have a hemispherical shape, for example. Furthermore, preferably, by forming the operation body 15 to have a shape that facilitates ease of operation with a fingertip, the height of the operation body 15 can be reduced further.

The operation body 15 may be detachable from the substrate 10. By dismounting the operation body 15 from the substrate 10, an input operation can be performed with the detection mechanism 50 that is capable of measuring the change in electrostatic capacity. In either case, the input operation performed by directly pressing the substrate 10 with a finger and the like can be detected with the force sensor units 40. Furthermore, in the input device 1 of the present example, since the force sensor units 40 are disposed in the vicinity of the four corners of the substrate 10, it is possible to have only one of the positions among the four positions to detect a strong force.

The input device 1 may include a plate-shaped substrate 10 that receives an input operation, supports 20 that elastically support the substrate 10, force sensor units 40 that detects the force applied to the substrate 10, and an operation body 15 disposed on the substrate 10. The force sensor units 40 may be disposed around the operation body 15 and are spaced apart from each other in different directions with respect to the operation body 15 when the substrate 10 is viewed in plan view.

With such a configuration, since the force sensor units 40 may be disposed around the operation body 15 in different directions, when an input operation is performed on the substrate 10 through the operation body 15, the force applied to the substrate 10 is accurately detected by each of the force sensor units 40. Accordingly, even if the height of the operation body 15 is reduced, the input operation through tilting of the substrate 10 can be performed and can be controlled in a desirable manner.

Furthermore, the substrate 10 has a rectangular shape in plan view, and the force sensor units 40 are each disposed in the vicinity of one of the four corners of the substrate 10. With such a configuration, since the force sensor units 40 are disposed in four directions around the operation body 15, and the separated distances between the operation body 15 and the force sensor units 40 are large, the force applied to the substrate 10 is detected in a further accurate manner.

Furthermore, the force sensor units 40 may include the elastic members EM, and the variable resistance portions VR in which the resistance values thereof change in accordance with the elastic deformation of the elastic members EM, the supports 20 include the accommodation spaces 25 in which the volume thereof elastically changes upon application of force to the substrate 10, and the accommodation spaces 25 accommodate the elastic members EM. With such a configuration, when force is applied to the substrate 10 with the input operation, the volumes of the accommodation spaces 25 elastically change, and elastic deformation occurs in the elastic members EM accommodated in the accommodation spaces 25. The resistance values of the variable resistance portions VR change in accordance with the elastic deformation of the elastic members EM, such that the force applied to the substrate 10 can be detected accurately. With the above configuration, since the elastic deformation needed to detect the force of the input operation occurs in the supports 20 that support the substrate 10, there is no need to separately provide a mechanism element in which displacement and elastic deformation for detecting the force occurs.

Furthermore, in the input device 1, the variable resistance portions VR each include two conductive members 41 and 42 that are disposed in the corresponding accommodation space 25 so as to capable of being in contact with each other and that have electric conductivities that are different from each other. The conductive members 41 serve as the elastic members EM, and each conductive member 41 may include a protruding surface that projects towards the portion that comes in contact with the corresponding conductive member 42. When the volume of each accommodation space 25 changes, the contact pressure between each of the corresponding two conductive members 41 and 42 changes.

With such a configuration, when the contact pressure changes, at least one of the conductive members deforms at the contact portion, and the contact areas of the two conductive members 41 and 42 change; accordingly, the resistance value of the conductive path passing through the contact portion of the two conductive members 41 and 42 changes.

Furthermore, the substrate 10 may have a first surface 10a and the second surface 10b that are parallel and opposed to each other. The first surface 10a may receive the input operation, and the supports 20 may support the substrate 10 from the second surface 10b. The two conductive members 41 and 42 may be disposed in the accommodation spaces 25 so as to be aligned in the longitudinal direction that is perpendicular to the first surface 10a and the second surface 10b. The lengths in the longitudinal direction of the accommodation spaces 25 decrease when the force applied to the substrate 10 in the longitudinal direction increases with the input operation.

With such a configuration, the force sensor units 40 can be configured easily.

Furthermore, the operation body 15 may include the base portion 15a that is in contact with the substrate 10, and the operation portion 15b that protrudes upwards from the base portion 15a. The base portion 15a may include the projections 15c that are provided so as to protrude sideways from the operation portion 15b in in plan view. With such a configuration, when the operation body 15 is tilted by operating force, since the projections 15c press the substrate 10, the substrate 10 can be tilted to an accurate orientation.

Furthermore, the substrate 10 may include the detection mechanism 50 that is capable of measuring an electrostatic capacity, and the detection mechanism 50 includes the plurality of electrodes 55 that are arranged in a matrix. The coordinate of an approaching object on the substrate 10 is detected by the change in electrostatic capacity measured by the electrodes 55. With such a configuration, the combined control that is a combination of the coordinate of an object on the substrate 10 detected by the detection mechanism 50 that is capable of measuring an electrostatic capacity, and the input operation, such as tilting and pressing of the operation body 15, detected by the force sensor units 40 can be performed.

Furthermore, the operation body 15 may be formed of a conductive material, and is disposed so as to be capable of sliding on the substrate 10. With such a configuration using the conductive operation body 15, the coordinate of the operation body 15 on the substrate 10 can be detected with the change in electrostatic capacity.

Furthermore, the operation body 15 may be provided so as to be detachable from the substrate 10, and the tilting operation of the substrate 10 can be performed at any position on the substrate 10. With such a configuration, the operation position of the operation body 15 can be changed according to the preference of the operator. Furthermore, the operation body 15 can be dismounted when not in use.

Furthermore, the operation body 15 may be a highly-rigid molded body. With such a configuration, by having the operation body 15 be a molded body so as to have a rigidity higher than that of the finger of the operator, operability becomes uniform and ease of operation is facilitated.

As described above, while the input device 1 has been described in a specific manner, the present invention is not limited to the exemplary embodiment described above, and various changes can be made and implemented within the scope of the invention. For example, the following modifications can be implemented, which falls under the technical scope of the present invention as well.

(1) In the present example, while the conductive members 42 are electrically connected to the electrode patterns 31 and 32 provided on the substrate 10, a change may be made such that a flexible wiring substrate including the electrode patterns 31 and 32 is provided on the base 80 side so that the electrode patterns 31 and 32 are on the base 80 side. Furthermore, the conductive members 42, serving as the elastic members EM, may be adhered to the substrate 10 and may have a protruding surface that projects towards the portion in contact with the conductive member 41 provided between the electrode patterns 31 and 32 on the base 80 side, and the conductive member 41 connected to the electrode patterns 31 and 32 may be configured as the side having the high resistance value. By so doing, the member connected to the processing unit 60 is separated into the detection mechanism 50 provided in the substrate 10, and the flexible wiring substrate provided with the electrode patterns 31 and 32 on the base 80 side; however, the print board including the electrodes 55 becomes more simple.

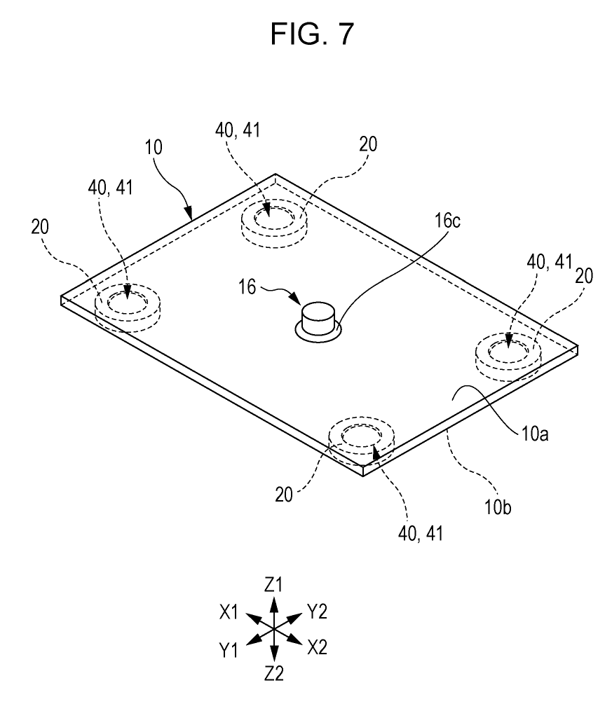

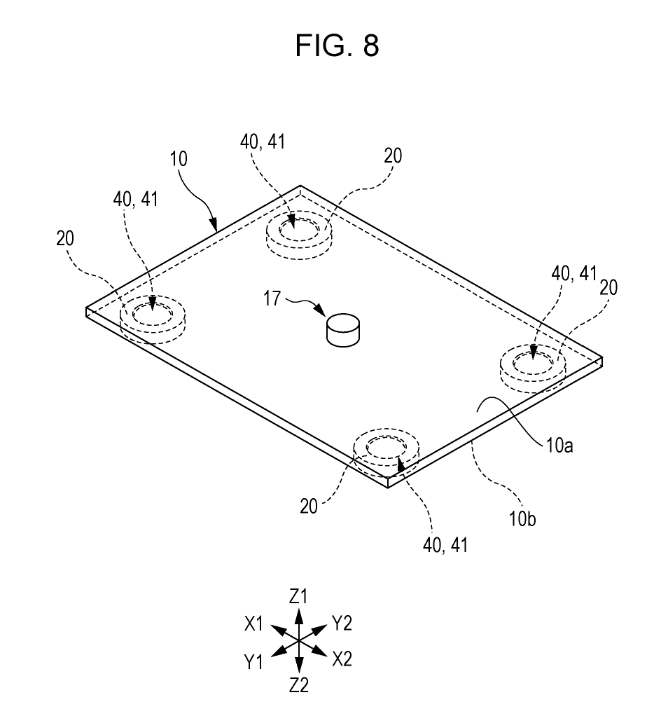

(2) In the present example, the shape of the operation body 15 is not limited to the shape illustrated in FIG. 1. Furthermore, the shape of the projections 15c is not limited to the shape illustrated in FIG. 1. FIG. 7 is a schematic diagram illustrating an operation body 16 of a first modification. As illustrated in FIG. 7, in the operation body 16, a projection 16c has a toric shape. Furthermore, while the operation body 15 includes the projections 15c, the operation body 15 may be shaped so as to have no projections 15c. FIG. 8 is a schematic diagram illustrating an operation body 17 of a second modification. As illustrated in FIG. 8, the operation body 17 has a columnar shape.

(3) In the present example, substrate 10 includes the detection mechanism 50 that is capable of measuring an electrostatic capacity; however, the configuration is not limited to the above. Furthermore, while the operation body 15 is formed of a conductive material, such as metal, the material may be an insulating material.

(4) In the present example, while the operation body 15 is detachable, the operation body 15 may be fixed to a specific position by adhesion or the like. Note that in such a case, preferably, the position is separate from the detection area of the detection mechanism 50. For example, the detection mechanism 50 may be disposed in a rectangular shape, the substrate 10 may include an extended portion that extend sideways from one side, and the operation body 15, the supports 20, and the force sensor units 40 may be disposed on or in the extended portion.

(5) In the present example, while the force sensor units 40 are each disposed in the vicinity of one of the four corners of the substrate 10, it is only sufficient that the force sensor units 40 are disposed around the operation body 15 and are spaced apart from each other in at least two directions with respect to the operation body 15 when the substrate 10 is viewed in plan view. By so doing, the input operation by tilting the substrate 10 and through the operation body 15 can be performed. Furthermore, by disposing the force sensor units 40 spaced apart from each other in three different directions, the tilting movement of the substrate 10 can be detected reliably.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input device comprising:
a plate-shaped substrate that receives an input operation;
supports that elastically support the substrate;
force sensor units that detect force applied to the substrate; and
an operation body disposed on the substrate,
wherein the force sensor units are disposed around the operation body and are spaced apart from each other in different directions with respect to the operation body when the substrate is viewed in plan view.

2. The input device according to claim 1,
wherein the substrate has a rectangular shape in plan view, and
wherein the force sensor units are each disposed in a vicinity of one of four corners of the substrate.

3. The input device according to claim 1,
wherein the force sensor units each include an elastic member, and a variable resistance portion, a resistance value of which changes in accordance with elastic deformation of the elastic member, and
wherein the supports each include an accommodation space, a volume of which elastically changes when force is applied to the substrate, the elastic member being accommodated in the accommodation space.

4. The input device according to claim 3,
wherein the variable resistance portion includes two conductive members in the accommodation space disposed so as to be capable of being in contact with each other, the two conductive members having electric conductivities that are different from each other,
wherein at least one of the two conductive members is the elastic member,
wherein at least one of the two conductive members has a protruding surface that projects towards a portion in contact with the other of the two conductive members, and
wherein when the volume of the accommodation space changes, a contact pressure between the two conductive members changes.

5. The input device according to claim 4,
wherein the substrate has a first surface and a second surface that are parallel and opposed to each other, the first surface receiving the input operation,
wherein the supports support the substrate from the second surface,
wherein in a corresponding accommodation space, the two conductive members are aligned in a longitudinal direction that is perpendicular to the first surface and the second surface, and
wherein when force in the longitudinal direction applied to the substrate is increased through the input operation, the length of the accommodation space in the longitudinal direction decreases.

6. The input device according to claim 1,
wherein the operation body includes a base portion in contact with the substrate, and an operation portion that protrudes upwards from the base portion, and
wherein the base portion includes a projection that protrudes sideways with respect to the operation portion in plan view.

7. The input device according to claim 1,
wherein the substrate includes a detection mechanism capable of measuring an electrostatic capacity, and
wherein the detection mechanism includes a plurality of electrodes arranged in a matrix, the detection mechanism detecting a coordinate of an approaching object on the substrate by a change in electrostatic capacity measured by the electrodes.

8. The input device according to claim 1,
wherein the operation body is formed of a conductive material and is disposed in a slidable manner on the substrate.

9. The input device according to claim 1,
wherein the operation body is provided so as to be detachable from the substrate, and
wherein the operation body is capable of performing an operation of tilting the substrate at any position on the substrate.

10. The input device according to claim 1,
wherein the operation body is a highly-rigid molded body.
